(19) United States
(12) Patent Application Publication
(10) Pub. No.: US 2020/0406318 A1
(43) Pub. Date: Dec. 31, 2020

(54) AUXILIARY FRAME CLEANING DEVICE

(71) Applicant: CITIC Dicastal CO., LTD., Qinhuangdao (CN)

(72) Inventors: Huiying LIU, Qinhuangdao (CN); Dong GUO, Qinhuangdao (CN)

(21) Appl. No.: 16/713,558

(22) Filed: Dec. 13, 2019

(30) Foreign Application Priority Data
Jun. 27, 2019 (CN) 201910565627.4

(51) Int. Cl. B08B 9/032; B23Q 11/12

(52) U.S. Cl. CPC B08B 9/0325; B08B 2209/032; B08B 2203/027; B23Q 11/12

(57) ABSTRACT

The disclosure discloses an auxiliary frame cleaning device which includes an upper working station and a lower working station, the upper working station is used for finishing the processes of loading, unloading and drying an auxiliary frame; the lower working station is used for finishing the process of cleaning the auxiliary frame; the upper working station consists of an auxiliary frame loading system, a vehicle body mounting hole sealing and adjusting system and an air supply system; the lower working station structure and the upper working station structure are consistent and symmetrically distributed.

### CROSS-REFERENCE TO RELATED APPLICATIONS

The present application claims benefit of Chinese Patent Application No. 201910565627.4, filed on Jun. 27, 2019, the contents of which are hereby incorporated by reference in their entirety.

### BACKGROUND

The auxiliary frame with mixed profiles and castings is more and more popular in the market. The auxiliary frame is formed by welding castings and profiles, herein the casting adopts a hollow casting process so as to reduce the weight of the auxiliary frame. The mixed type auxiliary frame has certain difficulty in cleaning, and machined aluminum scraps, casting residual sand, oil dirt and the like can be remained in the inner walls of the cavities of the castings and are not easy to remove.

### SUMMARY

The disclosure relates to the technical field of auxiliary frames, in particular to an auxiliary frame cleaning device.

In view of the above, the present disclosure aims to propose an auxiliary frame cleaning device, which can be used for automatic continuous production, through the ingenious design, high pressure water is injected into the casting cavity to wash residual aluminum scraps, residual sand and oil stains, the loading, unloading, drying process and the cleaning process are separated by utilizing the upper and lower working stations, so that the production takt is shortened, and the production efficiency is improved.

In order to achieve the above objective, the present disclosure provides the following technical solution.

An auxiliary frame cleaning device, including a frame, a positioning system, a sealing system and a cleaning system, a middle part of the frame being fixed with a servo motor, an output end of the servo motor being inwardly fixedly connected with a overturning plate, an upper surface of the overturning plate being provided with a positioning system, the positioning system including: an upper working station servo motor fixed on the overturning plate, herein an output end of the upper working station servo motor is upwards fixedly connected with an upper working station turntable, the upper working station turntable is provided with an upper working station clamp body which is perpendicular to the upper working station turntable, and the upper working station clamp body is provided with positioning columns corresponding to each auxiliary frame body mounting hole,

the sealing system including: a first cylinder and a first guiding rail which are fixed on the upper surface of the overturning plate at intervals, herein an output end of the first cylinder is fixedly connected with a first sliding table arranged on the first guiding rail, the first sliding table is provided with a plurality of flange plates each of which corresponds to a positioning column, and each flange plate is fixed with a nozzle,

the cleaning system including: an air compressor provided at an upper portion of the frame and a plurality of air outlets connected with the air compressor, a high pressure water pump provided at a lower portion of the frame and a plurality of water outlets connected with the high pressure water pump, herein the output ends of the air compressor and the high pressure water pump are detachably connected with the nozzle.

In an embodiment, the first sliding table is provided with a tape pipe connector connected with the nozzle, an output end of the air compressor is provided with a first tape pipe matched with the tape pipe connector, and an output end of the high pressure water pump is provided with a second tape pipe matched with the tape pipe connector.

In an embodiment, the first sliding table is provided with a second cylinder, the output end of the second cylinder is fixedly connected with a lifting platform, the lifting platform is provided with a second guiding rail, the second guiding rail is provided with a second sliding table, the flange plate is fixed on the second sliding table, and the nozzle is fixed on the flange plate.

In an embodiment, a third cylinder is fixed on the lifting platform, and the output end of the third cylinder is fixedly connected with the second sliding table.

In an embodiment, the positioning system and the sealing system are symmetrically arranged on an upper side and a lower side of the overturning plate, and the overturning plate is driven to rotate degrees by the servo motor, so that switching between an upper working station and a lower working station is realized.

In an embodiment, the plurality of air outlets are provided in the upper portion of the frame and correspond to an upper portion, a left side and a right side of the positioning system, and the water outlets are provided in the lower portion of the frame and correspond to the left side and the right side of the positioning system.

In an embodiment, the cleaning system includes a first feeding cylinder fixed on the frame, herein an output end of the first feeding cylinder is fixedly connected to a first feeding platform arranged on a first feeding guiding rail, the first feeding guiding rail is fixed on a supporting plate, the supporting plate is fixed on the frame, and the first feeding platform is provided with the air compressor.

In an embodiment, the cleaning system further includes a second feeding cylinder fixed on the frame, the output end of the second feeding cylinder is fixedly connected to a second feeding platform arranged on a second feeding guiding rail, the second feeding guiding rail is fixed on a supporting plate, the supporting plate is fixed on the frame, the second feeding platform is provided with a high pressure water pump, an input end of the high pressure water pump is connected with cleaning liquid, and the output end of the high pressure water pump is connected with the water outlet and the second tape pipe.

Compared with the related art, the auxiliary frame cleaning device has the following advantages that:

the present disclosure can be used for automatic continuous production, through the ingenious design, high pressure water is injected into the casting cavity to wash residual aluminum scraps, residual sand and oil stains, the loading, unloading, drying process and the cleaning process are separated by utilizing the upper and lower working stations, so that the production takt is shortened, and the production efficiency is improved.

### BRIEF DESCRIPTION OF DRAWINGS

The accompanying drawings forming a part of the present disclosure are used to provide a further understanding of the present disclosure, and the schematic embodiments and the descriptions of the present disclosure serve to explain the present disclosure and do not constitute an improper limitation of the present disclosure. In the drawings:

FIG. 1 is a front view of an auxiliary frame cleaning device of the present disclosure;

FIG. 2 is a left side view of the auxiliary frame cleaning device of the present disclosure;

FIG. 3 is a schematic diagram of the positioning and clamping of an auxiliary frame on the clamp body of the auxiliary frame cleaning device of the present disclosure;

FIG. 4 is an enlarged front view of the seal system of the auxiliary frame cleaning device of the present disclosure; and

FIG. 5 is an enlarged left side view of the seal system of the auxiliary frame cleaning device of the present disclosure;

### LIST OF REFERENCE SYMBOLS

1—frame, 2—first positioning column, 3—auxiliary frame, 4—sand cleaning hole, 5—lower working station clamp body, 6—second positioning column, 7—third positioning column, 8—fourth positioning column, 9—corner cylinder pressing claw, 10—lower working station turntable, 11—first bearing seat, 12—first shaft, 13—first bearing, 14—lower working station servo motor, 15—left shaft, 16—overturning plate, 17—upper working station servo motor, 18—second bearing seat, 19—second bearing, 20—second shaft, 21—upper working station turntable, 22—upper working station clamp body, 23—first guiding rail, 24—first sliding table, 25—first cylinder, 26—fixed plate, 27—second cylinder, 28—first guiding sleeve, 29—first guiding column, 30—first lifting platform, 31—nozzle, 32—flange plate, 33—first right sliding table, 34—second guiding rail, 35—first gear rack, 36—third cylinder, 37—first left sliding table, 38—first pipeline, 39—first cylinder, 40—second guiding column, 41—second guiding sleeve, 42—second lift table, 43—second lifting platform, 44—second guiding rail, 45—second sliding table, 46—fourth guiding rail, 47—second right sliding table, 48—second gear rack, 49—second left sliding table, 50—sixth cylinder, 51—second pipeline, 52—first taper pipe connector, 53—air compressor, 54—first taper pipe, 55—soft pipe, 56—upper air outlet, 57—left air outlet, 58—right air outlet, 59—first feeding platform, 60—first feeding cylinder, 61—first feeding guiding rail, 62—supporting plate, 63—right shaft, 64—servo motor, 65—second feeding guiding rail, 66—second taper pipe connector, 67—second feeding platform, 68—second taper pipe, 69—second feeding cylinder, 70—high pressure water pump, 71—suction pipe, 72—cleaning liquid, 73—left water outlet, 74—right water outlet.

### DETAILED DESCRIPTION

It should be noted that the embodiments and the features in the embodiments of the present disclosure may be combined with each other without conflict.

The technical solution of the present disclosure will be described more clearly and completely with reference to the accompanying drawings in conjunction with the embodiments, and it is apparent that the described embodiments are only some but not all embodiments of the present disclosure. All other embodiments which can be obtained by a person with ordinary skill in the art without making any creative work based on the embodiments of the present disclosure belong to the claimed scope of the present disclosure.

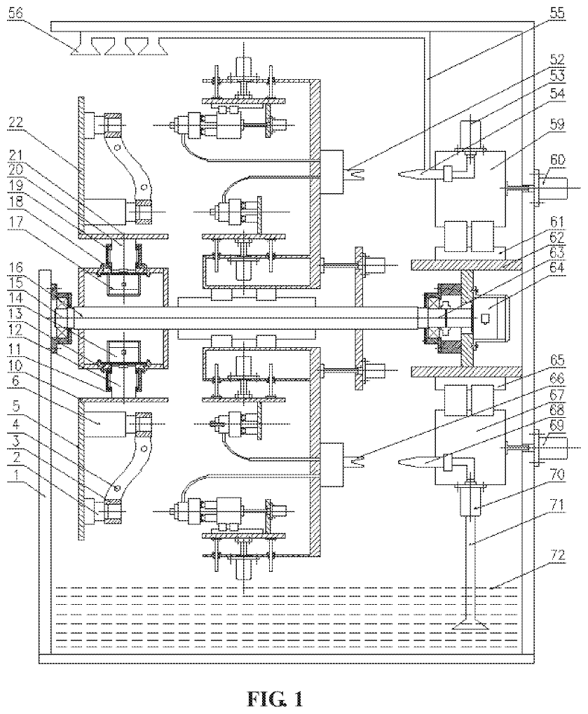

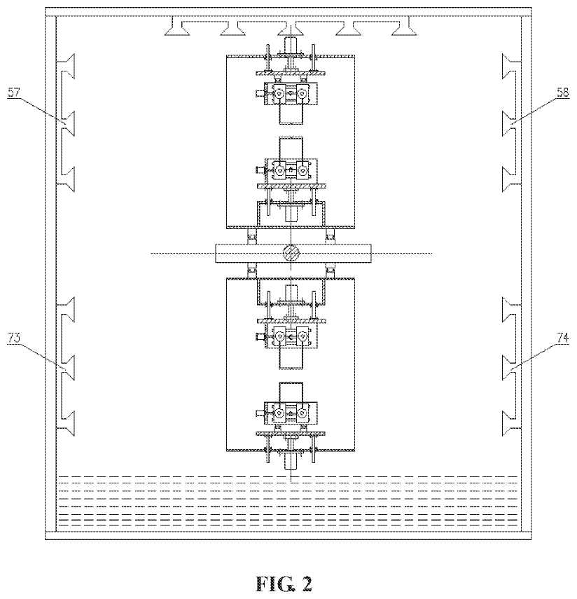

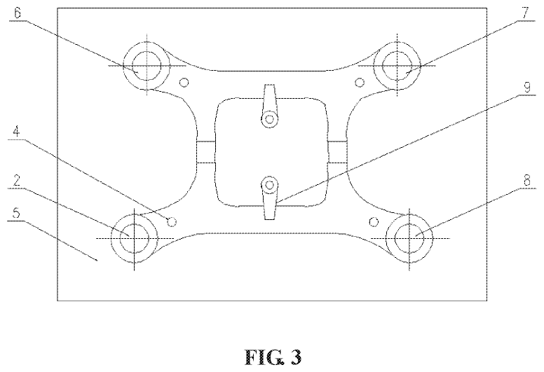

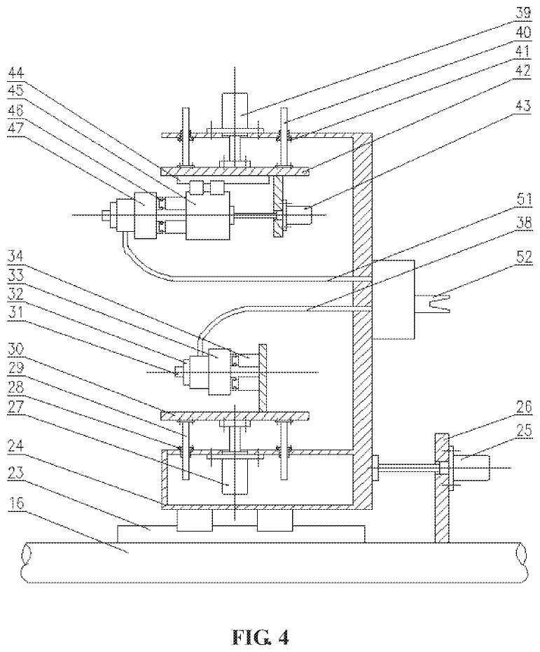

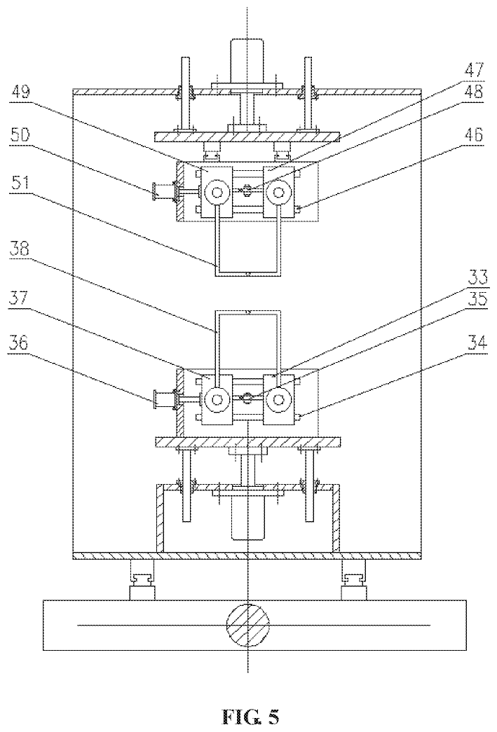

An auxiliary frame cleaning apparatus according to an embodiment of the present disclosure will be described with reference to FIGS. 1 to 5 in conjunction with the embodiment.

The auxiliary frame cleaning device includes an upper working station and a lower working station, herein the loading, unloading and drying process of the auxiliary frame are completed at the upper working station, and the cleaning process of the auxiliary frame is completed at the lower working station. The upper working station consists of an auxiliary frame loading system, a vehicle body mounting hole sealing and adjusting system and an air supply system, and the lower working station structure and the upper working station structure are consistent and symmetrically distributed.

The upper working station servo motor 17 is mounted on an overturning plate 16, and the output end of the motor is connected with an upper working station turntable 21 to control the rotation of the upper working station turntable 21. An upper working station clamp body 22 is mounted on the upper working station turntable 21, the auxiliary frame is mounted on the upper working station clamp body 22, and the auxiliary frame is positioned on the upper working station clamp body 22 through a first positioning column 2, a second positioning column 6, a third positioning column 7 and a fourth positioning column 8, herein the end face of a vehicle body mounting hole of the auxiliary frame is tightly fitted to the end faces of the positioning columns, and the auxiliary frame is clamped through a corner cylinder pressing claw 9. In an initial state, the front side of the upper working station clamp body 22 faces outwards, the auxiliary frame is placed on the upper working station clamp body 22 by a manipulator and clamped, then the upper working station servo motor 17 is started to drive the upper working station turntable 21 to rotate 180 degrees, so that the front side of the upper working station clamp body 22 faces inwards, and the loading of the auxiliary frame is finished. This is the auxiliary frame loading system. The structure below the overturning plate 16 is consistent with the structure above the overturning plate 16, a lower working station servo motor 14 is symmetrically mounted, the output end of the lower working station servo motor 14 is connected with a lower working station turntable 10, and a lower working station clamp body 5 is mounted on the lower working station turntable 10.

A first cylinder 25 is mounted on a fixed plate 26, the fixed plate 26 is mounted on the overturning plate 16, and the output end of the first cylinder 25 is connected to a first sliding table 24, the first sliding table 24 is mounted on a first guiding rail 23, and the first guiding rail 23 is fixed on the overturning plate 16. Under the guiding action of the first guiding rail 23, the first cylinder 25 controls the first sliding table 24 to move left and right. A second cylinder 27 is mounted on the first sliding table 24, the output end thereof is connected to a first lifting platform 30, a first guiding column 29 is mounted on the first lifting platform 30, the first guiding column 29 is matched with a first guiding sleeve 28, and under the guiding effect of the first guiding column 29, the second cylinder 27 controls the first lifting platform 30 to move up and down. A third cylinder 36 is fixed on the first lifting platform 30, the output end of the third cylinder 36 is connected to a first left sliding table 37, the first left sliding table 37 and a first right sliding table 33 are symmetrically mounted on a second guiding rail 34 and are connected through a first rack gear 35, the second guiding rail 34 is mounted on a vertical plate, and the vertical plate is mounted on the first lifting platform 30. Both the first left sliding table 37 and the first right sliding table 33 are mounted with a flange plate 32, a nozzle 31 is mounted in the center of each flange plate 32, both the nozzle on the first left sliding table 37 and the nozzle on the first right sliding table 33 are communicated to the first pipeline 38, and the first pipeline 38 is connected to a first taper pipe connector 52. A fourth cylinder 39 is fixed at the top of the first sliding table 24, the output end thereof is connected to the second lifting platform 42, a second guiding column 40 is fixed on the second lifting platform 42 and matched with a second guiding sleeve 41, and the fourth cylinder 39 controls the second lifting platform 42 to move up and down under the guiding action of the second guiding column 40. A fifth cylinder 43 is mounted on the second lifting platform 42, the output end thereof is connected to a second sliding platform 45, the second sliding platform 45 is mounted on the third guiding rail 44, the third guiding rail 44 is fixed on the second lifting platform 42, and the fifth cylinder 43 controls the second sliding platform 45 to move left and right under the guiding action of the third guiding rail 44. A sixth cylinder 50 is mounted on the second sliding table 45, the output end thereof is connected to a second left sliding table 49, the second left sliding table 49 and a second right sliding table 47 are symmetrically mounted on a fourth guiding rail 46 and are connected through a second gear rack 48, and the fourth guiding rail 46 is mounted on the second sliding table 45. Both the second left sliding table 49 and the second right sliding table 47 are mounted with a flange plate 32, a nozzle 31 is mounted in the center of each flange plate 32, both the nozzle on the second left sliding table 49 and the nozzle on the second right sliding table 47 are communicated to a second pipeline 51, and the second pipeline 51 is connected to the first taper pipe connector 52. The spatial positions of the four flange plates can be adjusted through the second cylinder 27, the third cylinder 36, the fourth cylinder 39, the fifth cylinder 43 and the sixth cylinder 50, so that the positions of the four flange plates correspond to the positions of the four vehicle body mounting holes of the auxiliary frame, and the four nozzles can enter the four vehicle body mounting holes of the auxiliary frame. After the loading of the auxiliary frame is finished, the first cylinder 25 is started to drive the first sliding table 24 to move leftwards, and the four flange plates are fitted to the surfaces of the four vehicle body mounting holes of the auxiliary frame, so that the vehicle body mounting holes are in a sealing state. This is the body mounting hole sealing adjusting system which utilizes the flange plates and the positioning columns on the clamp body to seal the auxiliary frame body mounting holes. When cleaning the auxiliary frames of different specifications, the positions of the four flange plates can be matched with the positions of the four vehicle body mounting holes of the auxiliary frame through the adjusting system, so that this device is high in universality. The adjusting system below the overturning plate 16 is consistent with the adjusting system above the overturning plate 16 and is symmetrically distributed.

The left end of the overturning plate 16 is connected with the left shaft 15, the right end of the overturning plate 16 is connected with the right shaft 63, the servo motor 64 is fixed on the supporting plate 62, the supporting plate 62 is fixed on the frame 1, the output end of the servo motor 64 is connected with the right shaft 63, and the overturning plate 16 can be controlled to rotate through the servo motor 64. The overturning plate 16 rotates 180 degrees, so that the circulation switching of the upper working station and the lower working station is realized.

A first feeding cylinder 60 is mounted on the side of the frame 1, the output end thereof is connected with a first feeding platform 59, the first feeding platform 59 is mounted on a first feeding guiding rail 61, and the first feeding guiding rail 61 is fixed on a supporting plate 62. Under the guiding action of the first feeding guiding rail 61, the first feeding cylinder 60 controls the first feeding platform 59 to move left and right. An air compressor 53 is mounted on the first feeding platform 59, and the output end of the air compressor 53 is divided into four paths: one path is connected with a first tape pipe 54, the first tape pipe 54 is used for being matched with a first tape pipe connector 52 to introduce compressed air into the four vehicle body mounting holes of the auxiliary frame, and dry the interior of the cavity; one path is connected with an upper air outlet 56 through a soft pipe 55 to dry the auxiliary frame from the upper side; one path is connected with the left air outlet 57 through a soft pipe to dry the auxiliary frame from the rear; and one path is connected with the right air outlet 58 through a soft pipe to dry the auxiliary frame from the front. This is the air supply system.

A second feeding cylinder 69 is mounted on the side of the frame 1 and is symmetrical to the first feeding cylinder 60, the output end of the second feeding cylinder 69 is connected with the second feeding platform 67, the second feeding platform 67 is mounted on the second feeding guiding rail 65, and the second feeding guiding rail 65 is fixed on the supporting plate 62. Under the guiding action of the second feeding guiding rail 65, the second feeding cylinder 69 controls the second feeding platform 67 to move left and right. A high pressure water pump 70 is mounted on the second feeding platform 67, and the output end of the high pressure water pump 70 is divided into three paths: one path is connected with a second tape pipe 68 which is used for being matched with a second tape pipe connector 66 to inject cleaning liquid into the four vehicle body mounting holes of the auxiliary frame, and clean the inside of the cavity of the auxiliary frame; one path is connected with a left water outlet 73 through a soft pipe to clean the auxiliary frame from the rear; and one path is connected with a right water outlet 74 through a soft pipe to clean the auxiliary frame from the front. This is the water supply system.

A working process of the auxiliary frame cleaning device includes the following steps: firstly, the auxiliary frame is placed on the upper working station clamp body 22 by a manipulator, the auxiliary frame is positioned on the clamp body through the first positioning column 2, the second positioning column 6, the third positioning column 7 and the fourth positioning column 8, and the auxiliary frame is clamped by the corner cylinder pressing claw 9. Then, the upper working station servo motor 17 is started to drive the upper working station turntable 21 to rotate 180 degrees, so that the front side of the upper working station clamp body 22 faces inwards, and the loading of the auxiliary frame is finished. According to the model of the produced auxiliary frame, the positions of the four flange plates is adjusted, so that the positions of the four flange plates correspond to the positions of the four vehicle body mounting holes of the auxiliary frame, and the four nozzles can enter the four vehicle body mounting holes of the auxiliary frame. After the auxiliary frame loading is completed, the first cylinder 25 is started to drive the first sliding table 24 to move leftwards, so that the four flange plates 32 are fitted to the surfaces of the four vehicle body mounting holes of the auxiliary frame, and the vehicle body mounting holes are in a sealing state. Then, the servo motor 64 is started to drive the overturning plate 16 to rotate 180 degrees, so that the auxiliary frame rotates to the lower working station, and the unloaded worktable rotates to the upper working station. Then, the second feeding cylinder 69 is started to drive the second tape pipe 68 to move leftwards, so that the second tape pipe 68 is inserted into the second tape pipe connector 66, the high pressure water pump 70 is started to inject high pressure cleaning liquid into the cavity of the auxiliary frame, the cleaning liquid can flow out from the sand cleaning hole to take away aluminum scraps, residual sand and oil stains, the left water outlet 73 and the right water outlet 74 can also output water simultaneously to clean the outer wall of the auxiliary frame in a spraying mode from the front side and the rear side. While the lower working station cleans the auxiliary frame, the upper working station carries out the loading of the second auxiliary frame and the sealing of the vehicle body mounting hole. After the cleaning is finished, the second tape pipe 68 is separated from the second tape pipe connector 66 to be retracted and reset, the servo motor 64 is started again to drive the overturning plate 16 to rotate 180 degrees, the cleaned auxiliary frame is switched to the upper working station, the second auxiliary frame to be cleaned is switched to the lower working station to start the cleaning; then the first feeding cylinder 60 is started to drive the first taper pipe 54 to be inserted into the first taper pipe connector 52, then the air compressor 53 is started to blow compressed air into the auxiliary frame cavity, and meanwhile dry the auxiliary frame from the upper side, the front side and the rear side; after the auxiliary frame is blown dry, the first tape pipe 54 and the first tape pipe connector 52 are disconnected, and the first tape pipe 54 is retracted and reset. Then, the first cylinder 25 is started to drive, the first sliding table 24 to be retracted and reset to release the sealing. Then, the upper working station servo motor 17 is started to drive the upper working station turntable 21 to rotate 180 degrees, the cleaned auxiliary frame is switched to the outer side and is taken down by the manipulator, then the next auxiliary frame is loaded, the first cylinder 25 is started again to drive the first sliding table 24 to move leftwards, and the four flange plates are fitted to the surfaces of the four vehicle body mounting holes of the auxiliary frame, so that the vehicle body mounting holes are in a sealing state. At this time, the cleaning of the auxiliary frame at the lower working station is finished, the second taper pipe 68 is disconnected from the second taper pipe connector 66 and is retracted and reset, the servo motor 64 is started again to drive the overturning plate 16 to rotate 180 degrees, the cleaned auxiliary frame is switched to the upper working station, and the auxiliary frame to be cleaned is switched to the lower working station. Therefore, the equipment enters a continuous operation state, the upper working station finishes the blow-drying, the unloading, the loading and the sealing of the vehicle body mounting hole of the auxiliary frame in sequence when the lower working station cleans the auxiliary frame, and the operation is circulated.

Compared with the related art, the auxiliary frame cleaning device has the following advantages that:

through the ingenious design, the loading, unloading, drying process and the cleaning process are separated and simultaneously carried out by utilizing the upper and lower working stations, so that the production takt is greatly shortened, and the production efficiency is improved.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

1. An auxiliary frame cleaning device, characterized in that: comprising a frame, a positioning system, a sealing system and a cleaning system, a middle part of the frame being fixed with a servo motor, an output end of the servo motor being inwardly fixedly connected with a overturning plate, an upper surface of the overturning plate being provided with a positioning system, the positioning system comprising: an upper working station servo motor fixed on the overturning plate, wherein an output end of the upper working station servo motor is upwards fixedly connected with an upper working station turntable, the upper working station turntable is provided with an upper working station clamp body which is perpendicular to the upper working station turntable, and the upper working station clamp body is provided with positioning columns corresponding to each auxiliary frame body mounting hole,
the sealing system comprising: a first cylinder and a first guiding rail which are fixed on the upper surface of the overturning plate at intervals, wherein an output end of the first cylinder is fixedly connected with a first sliding table arranged on the first guiding rail, the first sliding table is provided with a plurality of flange plates each of which corresponds to a positioning column, and each flange plate is fixed with a nozzle,
the cleaning system comprising: an air compressor provided at an upper portion of the frame and a plurality of air outlets connected with the air compressor, a high pressure water pump provided at a lower portion of the frame and a plurality of water outlets connected with the high pressure water pump, wherein the output ends of the air compressor and the high pressure water pump are detachably connected with the nozzle.

2. The auxiliary frame cleaning device according to claim 1, wherein: the first sliding table is provided with a tape pipe connector connected with the nozzle, an output end of the air compressor is provided with a first tape pipe matched with the tape pipe connector, and an output end of the high pressure water pump is provided with a second tape pipe matched with the tape pipe connector.

3. The auxiliary frame cleaning device according to claim 2, wherein: the first sliding table is provided with a second cylinder, the output end of the second cylinder is fixedly connected with a lifting platform, the lifting platform is provided with a second guiding rail, the second guiding rail is provided with a second sliding table, the flange plate is fixed on the second sliding table, and the nozzle is fixed on the flange plate.

4. The auxiliary frame cleaning device according to claim 3, wherein a third cylinder is fixed on the lifting platform, and an output end of the third cylinder is fixedly connected with the second sliding table.

5. The auxiliary frame cleaning device according to claim 4, wherein the positioning system and the sealing system are symmetrically arranged on an upper side and a lower side of the overturning plate, and the overturning plate is driven to rotate 180 degrees by the servo motor, so that switching between an upper working station and a lower working station is realized.

6. The auxiliary frame cleaning device according to claim 5, wherein the plurality of air outlets are provided in the upper portion of the frame and correspond to an upper portion, a left side and a right side of the positioning system, and the water outlets are provided in the lower portion of the frame and correspond to the left side and the right side of the positioning system.

7. The auxiliary frame cleaning device according to claim 6, wherein the cleaning system comprises a first feeding cylinder fixed on the frame, wherein an output end of the first feeding cylinder is fixedly connected to a first feeding platform arranged on a first feeding guiding rail, the first feeding guiding rail is fixed on a supporting plate, the supporting plate is fixed on the frame, and the first feeding platform is provided with the air compressor.

8. The auxiliary frame cleaning device according to claim 7, wherein: the cleaning system further comprises a second feeding cylinder fixed on the frame, an output end of the second feeding cylinder is fixedly connected to a second feeding platform arranged on a second feeding guiding rail, the second feeding guiding rail is fixed on a supporting plate, the supporting plate is fixed on the frame, the second feeding platform is provided with a high pressure water pump, an input end of the high pressure water pump is connected with cleaning liquid, and an output end of the high pressure water pump is connected with the water outlet and the second tape pipe.
